(19) United States
(12) Patent Application Publication
(10) Pub. No.: US 2010/0255212 A1
(43) Pub. Date: Oct. 7, 2010

(54) Microwave curing of impregnated wood

(75) Inventors: Andreas Treu, Nesoddtangen (NO); Holgen Militz, Bovenden (DE)

Correspondence Address: CHRISTIAN D. ABEL, ONSAGERS AS, POSTBOKS 6963 ST. OLAVS PLASS, OSLO, N-0130, NO

(73) Assignee: KEBONY ASA, Porsgrunn (NO)

(21) Appl. No.: 12/599,507

(22) PCT Filed: May 9, 2008
(86) PCT No.: PCT/NO08/00165

§ 371 Date: May 12, 2010

Related U.S. Application Data
(60) Provisional application No. 60/917,326, filed on May 11, 2007.

(51) Int. Cl. C08F 2/46

(52) U.S. Cl. 427/521

(57) ABSTRACT

A method of curing impregnated wood, comprising the steps of impregnating a wood sample with a polymerizable liquid, subjecting the wood sample to at least one heating iteration, wherein the wood is heated to between 70 to 140 degrees C. by MW radiation such that the formation of polymers takes place in the wood cells.

### BACKGROUND OF THE INVENTION

Modified wood is produced by first impregnating a wood specimen with a suitable amount of a polymerizable liquid, for example a solution of low molecular weight furan derivatives such as furfural, furfuryl alcohol bishydroxymethylfuran or combinations thereof. After impregnation the wood specimen is heated, whereby the polymerizable compounds are polymerized into a furan polymer in the wood cells. This polymerisation process is referred to as “curing” of the impregnated wood.

There exists a need for a more efficient method for curing impregnated wood.

### DESCRIPTION OF THE INVENTION

According to one aspect of the invention, impregnated wood is cured by the use of microwave radiation (hereafter “MW”).

In an embodiment of the invention, a wood specimen is first subjected to an impregnation step comprising a solution of furfuryl alcohol, furfural, bishydroxymethylfuran or other low molecular weight polymerizable furan derivatives. In one aspect of this embodiment, the impregnating solution may be diluted with water or an other suitable solvent to concentrations between 20 and 80%, and may further comprise suitable catalysts and/or initiators. Such an impregnation step will normally be of the “full cell” type.

Second a curing step where the impregnated wood is subjected to at least one MW heating iteration to a temperature of from 70 to 140° C., whereby the formation of furan polymers takes place in the wood cells. The microwave curing step can be repeated in a number of iterations that ensure an optimal curing of the impregnated wood, and even a final drying of the wood can be accomplished, reducing the need for a separate final drying process. According to one aspect of the invention, between one and 50 heating iterations are employed, and according to another aspect of the invention between 10 and 30 heating iterations are employed. In one aspect of the invention, the energy used for the microwave curing is in the range 10-200 kWh/(m³ wood). Various different microwave frequencies can be used, however, depending on the required penetration depth of the heat induced in the wood.

According to another embodiment of the invention the wood specimen is wrapped in foil prior to the heating step.

According to another aspect of the invention, the microwave radiation treatment can be included into a product grading system on conveyer belts.

According to another aspect of the invention, products obtainable by the above described method are provided. The furan polymer modified wood products obtainable by the described method will in one aspect of the invention have a polymer loading expressed as weight percent gain of the dry untreated parent wood of 10 to 100%. These modified wood products will be useful where demands on durability, hardness, dimensional stability and reduced moisture uptake are important.

The following examples illustrate that such curing can be accomplished without cracking of the wood, by microwave irradiation of the wood.

### EXAMPLES

### Materials and Methods

Planed, sound Scots pine sapwood samples (Pinus sylvestris) with dimensions 25 (r)×25 (t)×500 (1) mm³ were used for the evaluation.

The impregnation solution used in this study consisted of 26% furfuryl alcohol in water, with maleic anhydride and citric acid added as catalysts. The wood moisture content before impregnation was 11%.

After impregnation, the wood material was used directly for the microwave treatment. The samples can optionally be wrapped in plastic foil in order to avoid uneven polymerisation or evaporation while under microwave irradiation.

For the microwave (MW) treatment a magnetron with a frequency of 2.45 GHz was used with power levels from 600 W-1800 W. Wood samples were transported into the MW radiation chamber by using a conveyer belt. The speed of the conveyor belt was set between 10 mm/sec and 34 mm/sec.

The wood samples were subjected to several microwave irradiations in iteration. 10-30 iterations of microwave treatment at an energy consumption of the wood samples of 15-30 kWh/m³ were performed. It was seen that the 30 iterations could be performed in less than an hour under appropriate conditions.

The wood samples treated with these MW parameters are free of cracks, have reduced moisture content and have a brownish colour due to polymerisation of furfuryl alcohol.

The degree of fixation can be used as a method for analysing the amount of polymerized furfuryl alcohol.

### Analysis

After MW treatment the wood samples were leached out according to EN 84 and the water leachate was analysed for unreacted furfuryl alcohol. The degree of fixation was calculated as follows:

$$FG = ( \frac{W - l}{W} ) \cdot 100 [ \% ] \qquad ( 1 )$$

FG=degree of fixation [%]
W=amount of furfuryl alcohol that was brought into the wood specimen [mg/specimen]
1=amount of non polymerised furfuryl alcohol in the leachate [mg/specimen]

### Results

After 10-30 iterations and an energy consumption of 15-30 kWh/m³ per MW treatment the previously FA-impregnated wood samples are cured. Their colour has changed to brown, no cracks have been developed and they are slightly dried.

After leaching the treated pine wood samples according to EN 84 the water leachate was analysed for residual furfuryl alcohol using high pressure liquid chromatography (HPLC). The degree of fixation was calculated as described in Eq. 1.

The lowest degree of fixation calculated was for non-cured samples.

A degree of fixation above 95% was calculated for MW-treated samples with 30 process iterations (Microwave treatment 3).

### FUTURE WORK

Further research with the cured material will be performed to evaluate a possible change in material properties (fungal resistance, swelling/shrinking behaviour and strength properties) due to the microwave treatment in comparison to oven cured samples. The samples could have improved properties gained by microwave treatment.

1) A method of curing impregnated wood, comprising the steps of:
a) Impregnating a wood sample with a polymerizable liquid, said liquid comprising a low molecular weight furan derivative,
b) Subjecting the wood sample to at least one heating iteration wherein the wood is heated to between 70 to 140 degrees C. by MW radiation such that the formation of polymers takes place in the wood cells.

2) (canceled)

3) The method of claim 1, wherein the low molecular weight furan derivative is selected from furfural, furfuryl alcohol and bishydroxymethylfuran or combinations thereof.

4) The method of claim 3, wherein the MW radiation has a strength in the range of 10-200 kWh/(m3 wood)

5) The method of claim 4, wherein the wood is subjected to between 1 and 50 iterations.

6) The method of claim 5, wherein the wood is subjected to between 10 and 30 iterations.

7) The method of claim 6, further comprising the step of wrapping the wood sample in foil prior to the heating step.

8) A wood product obtained by the method of either of claim 1, or 3-7.
